(19) United States
(12) Patent Application Publication
(10) Pub. No.: US 2003/0187977 A1
(43) Pub. Date: Oct. 2, 2003

(54) SYSTEM AND METHOD FOR MONITORING A NETWORK

(75) Inventors: Charles D. Cranor, Morristown, NJ (US); Theodore Johnson, New York, NY (US); Oliver Spatscheck, Randolph, NJ (US)

Correspondence Address: AT&T CORP., P.O. BOX 4110, MIDDLETOWN, NJ, 07748, US

(73) Assignee: AT&T CORP.

(21) Appl. No.: 10/248,614

(22) Filed: Jan. 31, 2003

Related U.S. Application Data
(63) Continuation-in-part of application No. 09/911,989, filed on Jul. 24, 2001.
(60) Provisional application No. 60/395,362, filed on Jul. 12, 2002.

(51) Int. Cl. G06F 15/173

(52) U.S. Cl. 709/224

(57) ABSTRACT

An architecture for a network monitor is disclosed which permits flexible application-level network queries to be processed at very high speeds.

### Cross Reference to Related Applications

This application is a non-provisional application of provisional application “METHOD AND APPARATUS FOR PACKET ANALYSIS IN A NETWORK,” Serial No. 60/395,362, filed on Jul. 12, 2002, the contents of which are incorporated by reference herein. This application is also a continuation-in-part application of “METHOD AND APPARATUS FOR PACKET ANALYSIS IN A NETWORK,” Ser. No. 09/911,989, filed on Jul. 24, 2001, the contents of which are incorporated by reference herein.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

The present invention relates generally to communication networks and, more particularly, to monitoring communication networks.

The providers and maintainers of data network services need to be able to collect detailed statistics about the performance of the network. These statistics are used to detect and debug performance problems, provide performance information to customers, help trace network intrusions, determine network policy, and so on. A number of network tools have been developed to perform this task. For example, one approach is to use a “packet sniffer” program such as “tcpdump” that extracts packets from the network, formats them, and passes them to a user-level program for analysis. While this approach is very flexible, it is also very slow—requiring extensive processing for each packet and numerous costly memory transfers. Moreover, moderately priced hardware, such as off-the-shelf personal computer hardware, cannot keep pace with the needs of high-speed networks, for example such as the emerging Gigabit Ethernet standard.

Another approach is to load a special-purpose program into the network interface card (NIC) of a network monitoring device. Processing such as filtering, transformation and aggregation (FTA) of network traffic information can be performed inside the NIC. This approach is fast—but inflexible. As typically implemented in the prior art, the programs are hard-wired to perform specific types of processing and are difficult to change. Network operators typically require a very long lead time as well as interaction with the NIC manufacturer in order to change the program to perform a new type of network analysis.

### SUMMARY OF THE INVENTION

An architecture for a network monitor is disclosed which permits flexible application-level network queries to be processed at very high speeds. A network traffic query can be specified in a simple SQL-like realtime query language, that thereby allows the network operator to leverage off of existing database tools. The queries are analyzed and broken up into component modules, which allow the network monitor to perform processing such as filtering, transformation, and aggregation as early as possible to reduce the resources required to monitor the traffic. For example, and in accordance with one embodiment of the invention, queries can be broken into two types of hierarchical processing modules—a low-level component that can run on the network interface card itself, thereby reducing data before it reaches the main system bus; and a high-level component that may be run in either the kernel space or the user space and that can be used to extract application layer information from the network. This hierarchical division of processing allows the monitoring of high-traffic network links while maintaining support for a simple flexible query interface. By reducing data in key locations and as early as possible, this also makes it practical to use high-level languages such as Perl to interpret the results of the queries. Only the high-level query need be changed to quickly adapt the network monitor for new network problems.

The present invention thereby reduces network monitoring costs while maintaining the accuracy of the monitoring tools. These and other advantages of the invention will be apparent to those of ordinary skill in the art by reference to the following detailed description and the accompanying drawings.

### BRIEF DESCRIPTION OF DRAWINGS

FIG. 1 shows a block diagram illustrating the components of a network monitor architecture, in accordance with a preferred embodiment of an aspect of the invention.

FIG. 2 sets forth a diagram illustrating the process of generating the query-dependent network monitor software components from a query.

FIGS. 3A and 4A are illustrations of queries expressed in an advantageous query language. FIGS. 3B and 4B, respectively, are illustrations of these queries after being split up into two components—one running as an LFTA and one running as an HFTA.

FIG. 5 is an illustrative programming structure for an FTA component of the network monitor.

FIG. 6 is an illustrative application-level Perl interface for the network monitor.

FIG. 7 is an illustrative firmware architecture for the network monitor.

### DETAILED DESCRIPTION

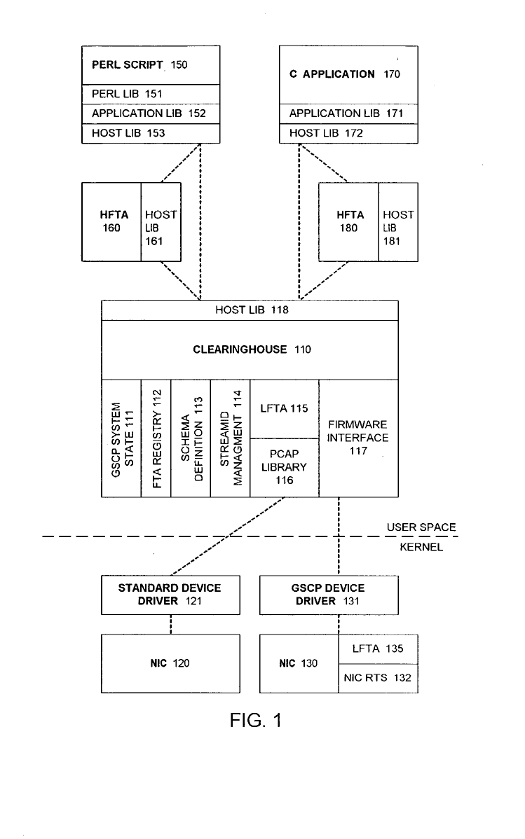

FIG. 1 depicts an example network monitoring configuration and shows the major components of the network monitor architecture, in accordance with a preferred embodiment of an aspect of the invention. The network monitor architecture allows highly flexible application-level network queries to be processed at gigabit speeds. It is advantageous for the queries to be written in an SQL-like query language, as further described below. The queries can then be compiled into executable modules which the inventors refer to as “FTAs”. “FTA” stands for filtering, transformation, and aggregation, although the processing capable of being performed by an FTA is not so limited. It is advantageous for the query compiler to generate a schema definition that describes the layout and semantics of FTA output. This information can be used by other FTAs or user-level applications to parse the FTA output. These data structures output by FTAs is referred to by the inventors as “tuples.” Each FTA generates one or more streams of tuples as output. Each stream of tuples generated by an FTA has an identifying number called the “stream ID.” Each stream ID is mapped to a schema. Thus, to decode FTA output, a tuple and stream ID is needed.

The FTAs are software modules that perform processing on network data, with the overriding principle of reducing data as early as possible to allow high-speed monitoring. Accordingly, it is advantageous to break up queries into hierarchical components, e.g. by defining two types of FTAs: low-level LFTAs and high-level HFTAs.

LFTAs: The low-level components can run on the network interface card itself, reducing data before it reaches the main system bus. LFTAs are small and targeted to run as part of the network interface card's firmware (if the hardware allows it), as further described herein.

HFTAs: The high-level query components may run either in kernel or user space and can be used to extract application layer information from the network. HFTAs are larger and designed to run on the host system, typically using the output of LFTAs as HFTA input.

Having the query compiler automatically break queries up into LFTAs and HFTAs allows the network monitor to perform processing such as filtering and aggregation as early as possible, and thus allows the monitoring of high-traffic links while maintaining support for a flexible SQL-like query interface. By reducing data in key locations, a single machine can handle multiple high-speed links. Early data reduction also makes it practical to use high-level languages such as Perl to interpret the results of the queries. Although described herein using the example of two types of FTAs, this aspect of the present invention is not so limited and may be readily extended to decomposing queries into multiple types of FTAs (e.g. three types of FTAs—one for execution on the network interface card, one for execution in kernel space, and one for execution in user space).

With reference to the embodiment shown in FIG. 1, the main components of the network monitor architecture are a clearinghouse 110, HFTAs 160 and 180, LFTAs 115 and 135, network interface cards (“NIC”s) 120 and 130, network interface card device driver 131, and user-level applications 150 and 170 show as a Perl script and as a C application respectively. Although FIG. 1 shows for illustration purposes two HFTAs 160, 180 and two user-level applications 150, 170, in general there can be any number of HFTAs, LFTAs and any number of user-level applications.

The clearinghouse 110 comprises code that can be automatically generated by the query compiler. The clearinghouse 110 has two main roles. First, it is used to track system state that must be visible to multiple user processes. In particular, the clearinghouse 110 tracks:

(i) the reachability of LFTAs and HFTAs, using what the inventors refer to as an FTA “registry” 112;

(ii) the schema definitions 113 of all the types of tuples generated by the FTAs;

(iii) the stream IDs 114 used for different FTA tuple streams; and

(iv) the remaining overall system state 111.

Second, the clearinghouse 110 is responsible for managing the LFTAs. The clearinghouse 110 is responsible for distributing the LFTAs output tuple streams to the appropriate HFTAs or user-level applications.

As mentioned above, the LFTAs can be configured to run either on the network interface hardware (illustrated by 135 in FIG. 1) or on the host (illustrated by 115 in FIG. 1). If the LFTAs execute on the network interface card, then this involves managing and updating the card's firmware, configuring the card's LFTAs, and collecting the output tuple streams from the card. If the LFTAs are configured to run on the host, then a standard library such as PCAP can be utilized to collect packets from the network interface. See V. Jacobson et al., “PCAP—Packet Capture Library,” http://www.tcpdump.org/pcap3_man.html. If the PCAP library 116 is used, then the LFTAs run within the clearinghouse process.The disadvantage of using a library such as PCAP is that the fitering and aggregation normally performed on the network interface card to reduce system load is instead performed on the host—thereby reducing the monitor's high-bandwidth performance. The advantage of using PCAP is that the flexible query interface system can be used with network interfaces that do not support firmware-based LFTAs. The performance penalty of PCAP can be partly alleviated by using a kernel-level packet filter. See, e.g., S. McCanne and V. Jacobson, “The BSD Packet Filter: A New Architecture for User-Level Packet Capture,” USENIX Winter, pages 259-70 (1993). Thus, the performance of the network monitor using PCAP can be comparable to other PCAP-based tools such as tcpdump.

The HFTAs 160, 180 receive tuple streams from LFTAs and perform processing such as filtering, transformation, and/or aggregation operations on them. Operations performed by the HFTAs typically require more processing power or memory than is available for the LFTAs. HFTA code, as further described herein, can be automatically generated by a query compiler. The number of HFTAs generated depends on the optimization performed by the compiler and may differ from the number of queries submitted to the compiler.

The device driver 131, unlike the standard kernel NIC device driver 121, manages the network interface cards 130 capable of running LFTAs 135. It provides a mechanism for the clearinghouse 110 to communicate with and update the card's firmware. It also manages the transfer of output tuples from the card 130 to the clearinghouse 110. The NIC firmware provides a run-time environment 132 on the network interface card 130 for LFTAs 135 generated by the query compiler. The firmware is typically cross-compiled using, for example, a C compiler on the host system.

Two illustrative types of user-level applications are shown in FIG. 1: an application written in the C programming language 170 and an application written in Perl 150. The C application consists of handcrafted code that manages FTA allocation and uses the tuple output stream generated by the queries to analyze network traffic. Typical C-level applications interface to the network monitor advantageously through an application interface library 171 that hides many of the details of the host library 172 from the application 170. If the functions provided by the application interface library 171 are not sufficient, then the application can interface directly with the host library 172. Perl script applications 150, on the other hand, can utilize a special library 151 that provides a perl wrapper around the network monitor. The main advantage of using the perl interface is its ease of use—all the details involved in running a query are handled by the perl wrapper. This includes compiling one or more queries, installing them in the network monitor, and running them. Output tuples are returned as perl associative arrays keyed by the names specified in the query.

The network monitor architecture allows queries to be formulated and applied to individual data packets or to streams of data, e.g., the data stream from a TCP connection. The latter case can be achieved through the use of a special TCP-reassembly HFTA that takes tuples containing TCP packets from a given connection as input and produces the TCP data stream as output over which other HFTAs can perform queries on.

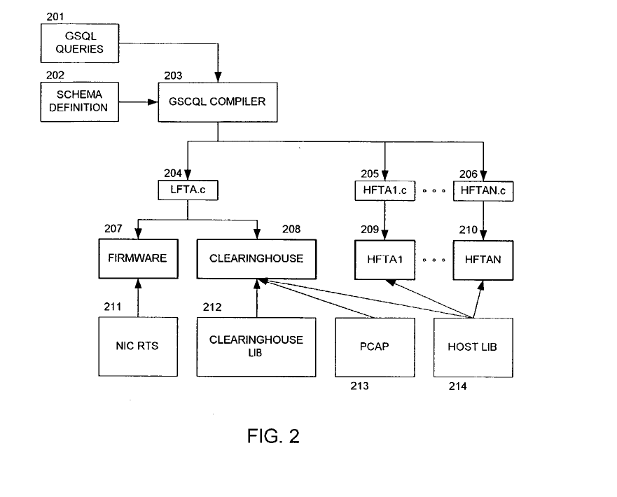

Before compiling and running a query, the query must be formulated using, for example, an SQL-like query language. An advantageous query language is specified below. Once the queries are ready, the first step to perform is to generate all query-dependent binaries. This process is illustrated in FIG. 2. First, the queries 201 are compiled into HFTAs 205 . . . 206, LFTAs 204, and schema definitions 202, using the query compiler 203. All LFTA code is placed in the LFTA.cfile, while the code for each HFTA is placed in its own C source file. Second, if the network monitor is using NIC firmware support, then the LFTA.c is cross-compiled and linked with the network interface card's run-time library 211 to generate a new version of the firmware 207. Third, the new clearinghouse program 208 is compiled. If the PCAP library 213 is being used, then the LFTAs are compiled directly into the clearinghouse 208. Finally, each HFTA source file 205 . . . 206 is compiled and linked with the host library 214 to generate a binary 209 . . . 210.

After all query dependent binaries have been built, it is advantageous to start and initialize them in the following order:

1. Clearinghouse: The clearinghouse is started and each LFTA and its schema are registered in the clearinghouse's FTA registry and schema database.

2. Firmware: If the firmware-based version of the network monitor is being used, then the clearinghouse will download the firmware into the NIC and initialize the card's LFTA runtime system.

3. HFTAs: Each HFTA process is started. The start up routine starts the HFTAs in the order of their IDs (e.g. “HFTA1” is started before “HFTA2”). This allows the query compiler to generate and manage dependencies between HFTAs. After each HFTA starts up, it registers itself and its schema definition with the clearinghouse.

Once the system binaries have been started, the network monitor is up—but no queries are running yet. To start query data processing, the application first asks the clearinghouse where the main FTA associated with the query resides. The clearinghouse consults its database (which was generated by the query compiler) and responds with the ID of the requested FTA. The ID consists of a process, an index number, and a schema. For HFTAs, the process can be the PID of the process managing the HFTA, while for LFTAs the process can be the PID of the clearinghouse (since it manages all LFTAs). The index is used to distinguish between multiple FTAs in a process. The schema is used to encode FTA parameters and decode tuple streams. Next, the application uses the clearinghouse to allocate a stream ID for the tuple output of the FTA the application will be using. Now, the application can call out to the process specified by the clearinghouse to create its FTA. THe application includes the stream ID and FTA parameters as part of the FTA creation call. If the application creates an HFTA that depends on other HFTAs or LFTAs for input, then that FTA is responsible for creating the FTAs it depends on. Once all necessary FTAs have been created, the application can activate its FTA. This causes the network monitor to start sending network data to the FTAs. Finally, the application subscribes to the stream ID of its FTA to start receiving its output tuples (this can typically be done through shared memory).

Most of the steps outlined above can be automated using the above-mentioned perl wrapper or C application-level interface.

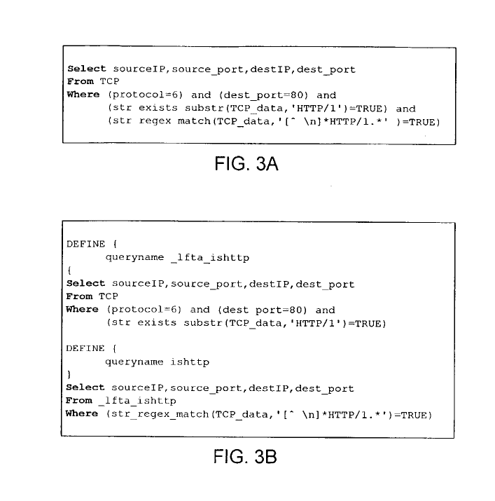

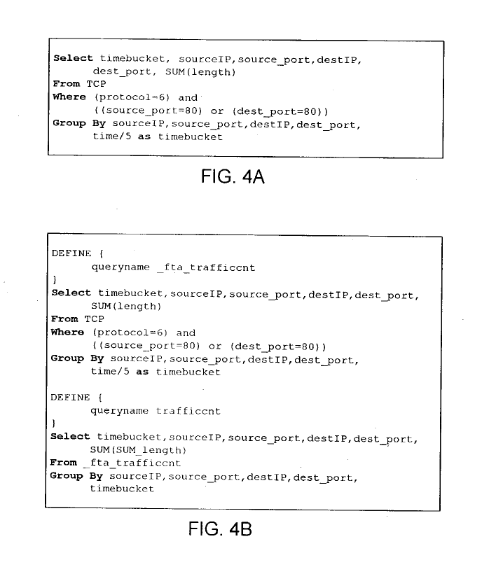

QUERIES.It is advantageous to formulate queries using a query language based on a standard database query language such as SQL. For example, FIGS. 3A and 4A are illustrations of queries expressed in a query language which the inventors call “GSQL.”. GSQL is a declarative language—users specify the properties of the data wanted, and the system determines a plan for implementing the specification. GSQL supports a restricted subset of the SQL query language, permitting selection and aggregation queries. With reference to FIG. 3A, suppose that one wishes to roughly determine how many TCP port 80 connections are actually used for HTTP traffic (port 80 is known to be often used for non-HTTP traffic in order to circumvent certain types of firewalls). One simple heuristic that could be used to determine this is to look for HTTP header strings in the TCP packet data. While this heuristic will not detect headers fragmented across multiple packets, it does handle the common case for most Web browsers. A GSQL selection query that produces a notification for each connection (source and destination address pair) over which an HTTP request is made would look like FIG. 3A. The keyword From indicates the source of the data. In this case, the monitored packets are interpreted as TCP/IP packets using the TCP schema, which provides a mapping between field names (such as sourceIP) and data elements in the packet. The list of scalar expressions following the Select keywords indicates which of the data elements of TCP to extract. The predicate following the Where keyword indicates the filter to apply to the packets before extracting their fields. Thus this query returns source and destination address of every connection through protocol 6 (TCP) to port 80 such that the string “HTTP/1” appears in the first line of the payload.

This selection query uses two functions, str_exists_substr, which checks for the existence of a substring and str_regex_match, which checks for the existence of a regular expression. This query contains some redundancy, because the substring function will return true whenever the regular expression function returns true. The selection query is written this way as an optimization. The str_regex_match is expensive to evaluate, and is not included in the LFTA run-time library. Therefore, it is advantageous for the network monitor to split this query into two components, one running as an LFTA and one as an HFTA, as shown in FIG. 3B. The DEFINE block sets properties of the query—in this case the name of the query and its output stream. The HFTA query inherits the designated name of the original query, while the LFTA query uses a mangled version. Note that the HFTA query specifies that it reads data from the LFTA query. The str_exists_substr function is a fast filter which removes most (but not all) of the packets that one does not want to see on this stream.

Another common monitoring task involves the collection of aggregate statistics of the packets. For example, one might be interested in the total bytes sent on each connection involving port 80 over five-second intervals. This information can be extracted by submitting the query set forth in FIG. 4A. The Group By keyword specifies the groups, or units of aggregation, for which statistics will be computed. In this case, it is the source and destination address pair, as well as the timebucket. The as keyword allows one to refer to the value time/5 as timebucket. time is a 1-second granular clock, so time/5 has the granularity of five seconds. The scalar expressions in the Select clause can contain references to aggregate functions, in this case SUM. The value reported is the group value, as well as the sum of the length of all packets within this group.

In general, it is assumed that the LFTA runtime environment has a small amount of memory available; therefore this type of aggregation query cannot be executed as an LFTA. However, the amount of data transferred can be greatly reduced by performing partial aggregation in a LFTA. Instead of storing every group in the LFTA, the most recently referenced N of them is stored. When a group is kicked out of the cache, it is sent to an HFTA query, which completes the aggregation. The compiler can automatically split aggregation queries, and in the example in FIG. 4A can create the two queries specified in FIG. 4B. In conventional SQL, the trafficcnt query would not return any results until all of the data had been read—that is, one would only receive results when the query is terminated. However, the network monitor knows that the time attribute is non-decreasing, and therefore that time/5 is non-decreasing. In the output schema of _fta_trafficcnt, timebucket is also marked as non-decreasing. Therefore, whenever timebucket changes, none of the groups which are in-memory will ever have a packet added to them in the future. Thus, they are flushed from memory into the output tuple stream.

Using the GSQL language provides two major benefits. First, it greatly simplifies the task of specifying the data stream to fetch from Gigascope, as a few lines of GSQL turn into hundreds of lines of C and C++ code. Second, Gigascope can readily interpret the GSQL query and apply a collection of transformation rules to produce optimized code. These optimizations are extremely difficult to perform correctly in handwritten code, and their complexity renders the handwritten code unmodifiable. In addition to the optimizations outlined above, it is also possible to apply code generation-time optimizations, and plan a collection of future optimizations (for example, to automatically generate the str_exists_substr predicate when the str_regex_match predicate is encountered).

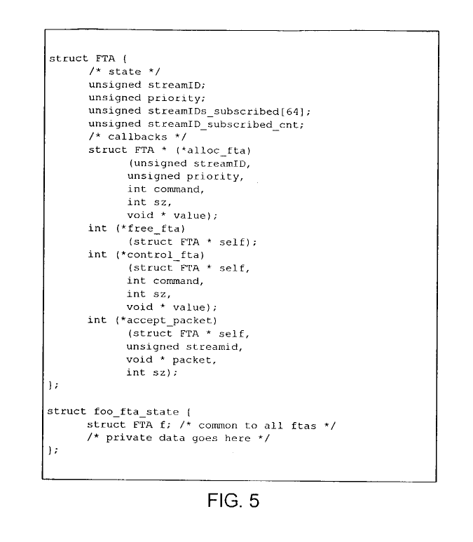

FTA INTERFACE.FTA code can be automatically generated from GSQL queries by a GSQL query compiler. The compiler can generate, for example, C source code for LFTAs and C++ source code for HFTAs. The interface for both types of FTAs can be defined by the FTA structure shown in the top part of FIG. 5. This structure would normally be embedded within an FTA's private state structure, e.g., foo_fta_state in FIG. 5). When an FTA is created, its state structure is allocated. FTA specific parameters and other FTA-specific information is stored in the private part of the state structure. The FTA structure is initialized with generic FTA information, and a pointer to this structure is returned as a result of the creation of the FTA.

The FTA structure contains both generic state information and pointers to API callback functions. The FTA structure's generic state information consists of the stream ID that should be used when generating output tuples, a priority, and for HFTAs a list of tuple stream IDs which are used for HFTA input. The FTA structure has the following API callback functions:

(i) alloc_fta: allocates new FTAs of the same type. The allocation parameters of the new FTA can be different than the current one.

(ii) free_fta: frees FTAs. This function is used when an FTA is no longer needed. After an FTA is freed, it can no longer be referenced.

(iii) control_fta: performs control operations on an FTA. It is advantageous to support the following control operations: LOAD_PARAMS updates the parameter set of an FTA and FLUSH flushes aggregate tuples from an FTA.

(iv) accept_packet: processes new network data. For LFTAs, the new data is a packet. For HFTAs, the new data is a tuple output by some other FTA.

The first three calls are generally initiated by the application, while the accept packet call is triggered by the arrival of new network data. Note that the accept packet callback is invoked only if the priority of the FTA is higher than the current system-wide network monitor priority (maintained by the Clearinghouse). This allows the network monitor to gracefully degrade performance if overload occurs.

HOST LIBRARY.The host library provides interprocess communication between the three types of components thatrun on it: applications, HFTAs, and the clearinghouse process. It is used to control FTAs and to manage the transfer of tuple streams between processes. For each process that uses the host library, the library maintains: (i) a list of local FTAs, including which local FTAs are currently active; (ii) a list of remote FTAs referenced by local FTAs, this list including information on how to reach the remote FTAs (e.g. remote process ID); (iii) a list of remote tuple streams that the local process subscribes to; (iv) a list of processes that are subscribed to locally generated tuple streams; and (v) a list of processes currently blocked waiting for data to be generated by the local process. The host library handles requests to invoke FTA API functions, to activate or deactivate an FTA, and to subscribe or unsubscribe from a tuple stream ID. It handles requests from both the local process and any remote process the local process communicates with.

It is advantageous for the host library to have three operating modes, one for each environment it operates in. It is important to use the proper mode for the current environment in order to avoid deadlock. The modes are:

1. APPLICATION MODE: In application mode, all calls are made from the application into the library. Tuple data from subscribed streams are received using the blocking gscp_get_buffer function call. This function has a timeout parameter to limit the amount of time an application blocks.

2. HFTA MODE: In HFTA mode, bost library function calls are used to manage FTAs created by the HFTA and to post tuple data, while callbacks are used to manage local instances of the HFTA and to track processes subscribed to locally generated output tuples. Note that in order to avoid deadlocks, HFTAs cannot call the blocking gscp_get_buffer function. Instead, the HFTA's accept_packet callback is used for data reception.

3. CLEARINGHOUSE MODE: Clearinghouse mode is identical to HFTA mode, with the addition of an additional set of callback functions for clearinghouse management. See below. The host library is directly used mainly by code automatically generated by the GSQL query compiler. Applications normally use an additional simplified library, described below, which is layered over the top of the more complex host library.

Internally, the host library can utilize a message queue and sets of shared memory regions to perform IPC. Messages on the queue are tagged with the process ID of the destination process. This allows each process to receive messages selectively using a single message queue. The shared memory regions contain ring buffers that are asyncronously written by tuple producers and read by tuple consumers. To avoid blocking producers, tuples are dropped if the ring buffer is full. Thus, it is important to size the shared memory region appropriately.

CLEARINGHOUSE FUNCTION.The clearinghouse manages LFTA processing and tracks global state. For LFTAs, the clearinghouse: (a) manages the LFTAs running in network interface firmware if hardware support is enabled; (b) obtains network packets from the PCAP library and performs LFTA processing on them if hardware support is not available; (c) handles application and HFTA calls to LFTAs; and (d) keeps a list of active LFTAs and active stream IDs. The clearinghouse process can provide three registries that help maintain global state for the network monitor. The first registry can track the locations of all the FTAs in the system. It also can associate a schema with each FTA. This allows applications and HFTAs to find and communicate with the process responsible for a given FTA based on the FTA's name. The second registry can track stream ID usage. Each active stream ID is mapped to the tuple output stream of a particular FTA. This registry can also be used to allocate new stream IDs when FTAs are created. The third registry can track global system state. For example, this can consist of global priority level. An FTA should have a priority greater than or equal to this global level in order to receive data. This mechanism provides a way for the network monitor to throttle itself if it becomes overloaded.

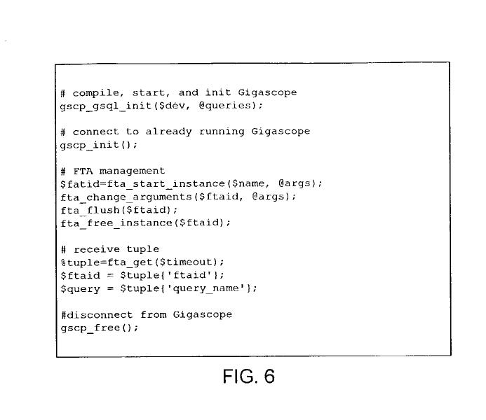

APPLICATION INTERFACE.It is advantageous to provide an easy-to-use application library that hides the complexity of the network monitor architecture. FIG. 6 sets forth an example perl interface for the network monitor. A similar C interface may be readily devised by one of ordinary skill in the art. Applications can initialize the network monitor in one of two ways: with gscp_gsql_initor with gscp_init. The gscp_gsql_init function is used to start the network monitor with a fresh set of queries. The gscp_gsql_init function takes a device and an array of GSQL query strings. It compiles the queries and starts the clearinghouse and HFTA processes usuing the process described above. The gscp_init function is used to connect an application to a network monitor that is already running. The application has access to all queries compiled into the currently running clearinghouse process.

Once the network monitor is initialized, the perl script can create FTAs. The fta_start_instance function takes a query name and an array of initialization parameters for that query. It creates and activates all necessary FTAs and tuple streams. It returns an FTA that can be used in subsequent calls to manage the query. Once the query is running, the application can change the parameters of the query by calling the fta_change_arguments function with an FTA ID and a new set of parameters. The aggregate values in the tuple stream can be flushed out by using the fta_flush function. To stop a query, the fta_free_instance function is provided. This function handles all architectural details of freeing FTAs including unsubscribing stream IDs, deactivating FTAs, and freeing FTA resources.

The Perl applications can receive tuples from any of their active queries using the fta_get function. This function takes a timeout in milliseconds, and it returns the tuple as an associative array. If the fta_get call times out, an empty associative array is returned. The FTA ID and query name of the query that generated the tuple are returned in the associative array, as shown in FIG. 6. In addition to those two key/value pairs, the associative array will also contain one key/value pair for each field in the tuple. The keys in these pairs are identical to the names used in the select clause of the query used to generate the tuple. The details of parsing the tuples using the schema definition generated by the FTA compiler are hidden behind the fta_get interface.

When the application is finished, it can free all network monitor related state by calling the gscp_free function. If gscp_gsql_init was used to connect to the network monitor, then gscp_free kills all network monitor-related processes and halts any firmware that was started by gscp_gsql_init.

FIRMWARE.The present invention is not limited to any particular host or NIC architecture. The host computer as is well known in the art can include any device or machine capable of accepting data, applying prescribed processes to the data, and supplying the results of the processes; for example and without limitation a digital personal computer having an appropriate interface for the NIC, e.g., a PCI local bus slot. The NIC, as is well known in the art, can comprise one or more on-board processors, hardware interfaces to the appropriate network and host, and memory which can be used to buffer data received from the data network and for storing firmware program instructions. For example, and without limitation, the NIC can be a programmable Ethernet PCI local bus adaptor such as the Alteon Tigon gigabit ethernet card (formerly owned by Alteon and now owned by the 3Com Corporation). The Alteon Tigon gigabit ethernet card has a 1000base-SX fiber PHY as its physical interface to the network. It has a PCI interface, 1MB of on-board SDRAM, a DMA engine, and two 86 MHz MIPS-class CPUs for firmware to run on. The Alteon Tigon firmware was optimized for normal interactive network use rather than for network monitoring. Accordingly, it is advantageous to modify the conventional firmware—retaining the IEEE 802.3z gigabit auto-negotiation state machine—while providing a device driver and debugging environment that supports loading cross-compiled firmware binaries into the card, examining card register and memory locations, and displaying the firmware's message buffer.

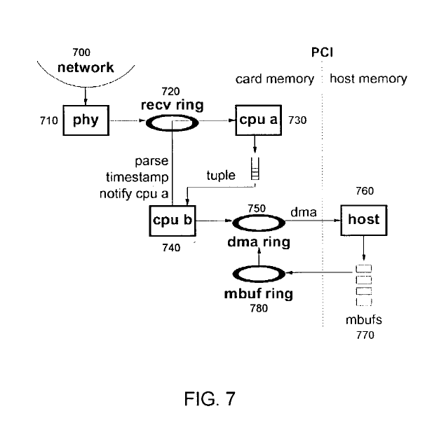

FIG. 7 sets forth an abstract diagram illustrating the software architecture for advantageously modified firmware for the Alteon Tigon gigabit ethernet card. Data arriving from the network PHY 710 is placed in a receive ring buffer 720 by the card's hardware. The arrival of new data generates an event on CPU B 740. CPU B 740 parses the data, checking for any ethernet-level receive errors. It then timestamps the packet and sends a notification event to CPU A 730. CPU A 730 receives the notification event and extracts a pointer to the packet data and timestamp information from the receive ring buffer 730. CPU A 730 then performs LFTA processing on the received packet. If the LFTAs finish with the packet, then CPU A 730 frees it in the receive ring. LFTAs can retain a reference to the packet if they wish to immediately send a large chunk of data from the packet to the host in a tuple. This is more efficient than copying the data from a packet to a tuple buffer. At some point, the LFTAs running on CPU A 730 will need to generate output tuples for the host. To do this, the LFTA allocates a new tuple buffer, initializes it, queues it, and sends a notification to CPU B 740. CPU B 740 receives the notification from CPU A730, dequeues the tuple, and allocates an mbuf 770 (kernel buffer) for it from the mbuf ring 780. It then gets a DMA descriptor from the DMA ring and programs the card's DMA engine to DMA the tuple data from the tuple buffer to the mbuf. When the DMA complese, CPU B 740 will free the tuple and update its mbuf ring consumer pointer. The network monitor device driver in the host 760 periodically polls the mbuf ring consumer pointer to see if any tuples haven been generated. If so, it queues them for upload to the clearinghouse process and refills the mbuf ring with free mbufs.

In addition, the host can also send commands to both CPU A 730 and CPU B 740. Commands sent to CPU A 730 are used to manage LFTAs, while commands sent to CPU B 740 are used to enable/disable the PHY 710 and to load new mbufs into the mbuf ring. The main constraint of the Tigon card is the memory bus bandwidth on the card whcih is shared between the PHY, CPU A, CPU B, and the DMA engine. CPU A and CPU B also each have their own private memory buses with 16KB and 8KB of memory, respectively. To reduce local memory bus load and achieve good performance, it is important to move the critical code path into this private memory.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, the detailed description describes an embodiment of the invention with particular reference to Gigabit Ethernet. However, the principles of the present invention are equally applicable to most other line types, including 10-100 MB Ethernet and OC48c.

1. A method of monitoring traffic in a network comprising the steps of:
receiving a network traffic query;
decomposing processing of the network traffic query into a high-level processing module and a low-level processing module so that the low-level processing module can be executed on a network interface and the high-level processing module can receive output from the low-level processing module, thereby creating data responsive to the network traffic query.

2. The invention of claim 1 wherein the low-level processing module is tracked in a registry.

3. The invention of claim 2 wherein a clearinghouse is used to maintain the registry and to direct the output from the low-level processing module to the high-level processing module.

4. The invention of claim 3 wherein the clearinghouse also maintains a schema definition for the output of the low-level processing module.

5. The invention of claim 4 wherein high-level processing modules can subscribe through the clearinghouse to the output of the low-level processing modules.

6. The invention of claim 5 wherein the network traffic query is expressed in a high-level query language.

7. The invention of claim 6 wherein the step of decomposing the processing of the network traffic query is performed by a query compiler.

8. The invention of claim 7 wherein the low-level processing module is expressed in firmware on the network interface which processes and reduces data from the network before leaving the network interface.

9. The invention of claim 8 wherein the high-level processing module has access to application-layer information in processing the output from the low-level processing module.

10. The invention of claim 9 wherein the network is a Gigabit Ethernet network.

11. The invention of claim 10 wherein traffic on the network comprises Internet Protocol datagrams.

12. A system for monitoring traffic in a network comprising:
one or more low-level processing modules that executes on a network interface;
one or more high-level processing modules that receive output from the low-level processing modules; and
a clearinghouse that tracks the low-level processing modules in a registry and directs the output from the low-level processing modules to the high-level processing modules.

13. The invention of claim 12 wherein the clearinghouse also maintains a schema definition for the output of the low-level processing modules.

14. The invention of claim 13 wherein the high-level processing modules can subscribe through the clearinghouse to the output of the low-level processing modules.

15. The invention of claim 14 wherein the high-level processing modules and the low-level processing modules are decomposed by a query compiler from a network traffic query.

16. The invention of claim 15 wherein the network traffic query is expressed in a high-level query language.

17. The invention of claim 16 wherein the low-level processing module is expressed in firmware on the network interface which processes and reduces data from the network before leaving the network interface.

18. The invention of claim 17 wherein the high-level processing module has access to application-layer information in processing the output from the low-level processing module.

19. The invention of claim 18 wherein the network is a Gigabit Ethernet network.

20. The invention of claim 19 wherein traffic on the network comprises Internet Protocol datagrams.

21. A device-readable medium storing program instructions for performing a method of monitoring traffic in a network, the method comprising the steps of:
receiving a network traffic query;
decomposing processing of the network traffic query into a high-level processing module and a low-level processing module so that the low-level processing module can be executed on a network interface and the high-level processing module can receive output from the low-level processing module, thereby creating data responsive to the network traffic query.

22. The invention of claim 21 wherein the low-level processing module is tracked in a registry.

23. The invention of claim 22 wherein a clearinghouse is used to maintain the registry and to direct the output from the low-level processing module to the high-level processing module.

24. The invention of claim 23 wherein the clearinghouse also maintains a schema definition for the output of the low-level processing module.

25. The invention of claim 24 wherein high-level processing modules can subscribe through the clearinghouse to the output of the low-level processing modules.

26. The invention of claim 25 wherein the network traffic query is expressed in a high-level query language.

27. The invention of claim 26 wherein the step of decomposing the processing of the network traffic query is performed by a query compiler.

28. The invention of claim 27 wherein the low-level processing module is expressed in firmware on the network interface which processes and reduces data from the network before leaving the network interface.

29. The invention of claim 28 wherein the high-level processing module has access to application-layer information in processing the output from the low-level processing module.

30. The invention of claim 29 wherein the network is a Gigabit Ethernet network.

31. The invention of claim 30 wherein traffic on the network comprises Internet Protocol datagrams.
